(19) United States
(12) Patent Application Publication
(10) Pub. No.: US 2014/0259620 A1
(43) Pub. Date: Sep. 18, 2014

(54) HOSE RETENTION SYSTEM

(71) Applicants: Thaddeus R. Hicks, Woodinville, WA (US); Michael A. Stoy, Bothell, WA (US)

(72) Inventors: Thaddeus R. Hicks, Woodinville, WA (US); Michael A. Stoy, Bothell, WA (US)

(21) Appl. No.: 13/800,714

(22) Filed: Mar. 13, 2013

(51) Int. Cl. F16L 3/10; F16M 13/02

(52) U.S. Cl. CPC F16L 3/10; F16M 13/02
USPC 29/525.01; 248/75

(57) ABSTRACT

A hose retainer system that is adapted for securing individual hoses of auxiliary hydraulic systems on excavators. The present invention is a quick and easy install kit for binding several one or more auxiliary hydraulic hoses together on the existing tubes of the excavator in an organized manner.

### FIELD OF THE INVENTION

This invention relates generally to a clamp for use in securing one or more hoses individually to existing tubes such as on an excavator or other equipment, and more particularly to securing multiple hoses to existing tubes.

### BACKGROUND OF THE INVENTION

Cable ties, also known as zip ties or tie-wraps, are generally well-known for easily attaching multiple hoses to a system that has existing tubes in place. For example, attaching hoses of auxiliary hydraulic systems on excavators.

To date, all of the installations known to the inventors simply use cable ties which are tightened around each hose at intervals to attach the hoses of the auxiliary hydraulic systems to the existing tubes on the excavators. Sometimes cable ties are used in combination with a bulkhead bracket to secure the end of the hoses at the ends of the boom or arm on the excavator.

However, the traditional cable tie attachment is a flexible and lacks the ability to maintain the position of the hose on the tube, but let the hoses ‘walk’ on the tube. Furthermore, the cable tie attachment fails to provided for efficiently and reliably attaching multiple hoses to the same tube. Cable tie attachments fail to ensures protection of the hose from damage and instability.

### SUMMARY OF THE INVENTION

The present invention is a hose anchor adapted for securing individual hoses of auxiliary hydraulic systems on excavators. The present invention is a quick and easy install kit for binding one or more auxiliary hydraulic hose together on a existing tubes of the excavator in an organized manner.

The problem solved by the present invention is the easy attachment of multiple hoses to a system that has existing tubes in place. In contrast, the installations of the prior art simply use cable ties to attach the hoses to the tubes. Sometimes the cable ties are used in combination with a bulkhead bracket to secure the end of the hoses at the ends of the boom or arm on the excavator. The prior art does not provide any multi-hose style clamps that are useful in this application. The prior art designs only provide for binding together wires and keeping the wires organized. The sizes of the openings are too small and frail to be useful for hoses. Furthermore, merely re-sizing such wire organizers would fail to provide means for attachment of hydraulic or other hoses to existing tubes, which is one aspect of the present invention. Additionally, mere re-sizing of such wire organizers would fail to provide offset spacing and stability of the individual hoses that has been determined by the inventors of the present invention to provide increased space efficiency and protection of the individual hoses in general, and individual hoses of auxiliary hydraulic systems on excavators, in particular.

According to one aspect of the invention a hose anchor is provided that is adapted for securing individual ones of a plurality of hoses. The hose anchor includes a hose support having an outer surface and an inner surface with an opening therebetween, the inner surface is adapted to substantially encompass an external tube member. An array of receivers is positioned on the outer surface of the hose support, with each receiver being formed an opening thereinto and also being adapted for receiving an extraneous element into the receiver, such as but not limited to an individual hose of an auxiliary hydraulic system on an excavator. A retainer is adapted for retaining the hose or other extraneous element received into each receiver; and a securing mechanism is adapted for securing the hose support to the external tube member. The hose support is optionally formed of a resiliently deformable material, such as but not limited to a thermoplastic elastomer. The plurality of receivers are expected to be mutually parallel, and the inner surface of the hose support is expected to be mutually parallel with the plurality of receivers.

According to one aspect of the invention, the securing mechanism is either one of: an intrinsic securing element continuous with the hose support, or an extraneous securing element independent of the hose support.

According to another aspect of the invention, the hose support is further formed of a core between a pair of flanges spaced apart to receive the securing mechanism therebetween. When the securing mechanism is the independent extraneous securing element, the securing mechanism is formed of an elongated strap portion of a stretch-resistant or nonstretchable material that is sized to be received between the pair of spaced apart flanges. By example and without limitation, the independent extraneous securing element is either one of a hose clamp, or a cable tie.

According to another aspect of the invention, the hose support includes instead the intrinsic securing element, and the opening into each receiver is formed with an individual intrinsic retainer.

According to one embodiment of the hose anchor of the invention, each receiver is formed with a concave inner surface that defines a substantially part-circular notch with the opening thereinto and directed away from the outer surface of the hose support, and the individual intrinsic retainer is formed with a stiffness about the opening that is greater than a stiffness of a wall partially surrounding the opening, which greater stiffness about the opening effectively retains the hose in the receiver.

According to another embodiment of the hose anchor of the invention, each receiver is instead formed with a concave inner surface defining a substantially part-circular notch with the opening thereinto and directed away from the outer surface of the hose support, and the individual intrinsic retainer includes a ratchet formed of a pawl formed on a flexible stem and a flexible arm having a gear tooth matched to the pawl and positioned adjacent to the opening into the concave inner surface, which ratchet and gear tooth close the opening of the receiver and effectively retain the hose in the receiver.

According to another embodiment of the hose anchor of the invention, when the securing element of the hose support is intrinsic thereto, the intrinsic securing element is either one of: an elongated flexible strap portion formed with a gear rack, and an open case portion adapted to receive the strap portion thereinto and having a ratchet within the open case that is adapted for interlocking with the gear rack of the strap portion; or a pair of interleaving arms forming the opening of the hose support, with the interleaving arms being formed with mutually interlocking gear racks.

According to another aspect of the invention, a method is provided for attachment of multiple hoses to a system that has existing tubes in place.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1-4 illustrate an annular hose support that is adapted for organizing and securing individual ones of a plurality of hoses of an auxiliary hydraulic system to pre-existing external tubes of an excavator or other equipment in a manner that permits the hose to deliver accurate hydraulic flow and pressure, wherein FIG. 1 is a first pictorial view of the annular hose support, FIG. 2 is a side view thereof, FIG. 3 is another pictorial view thereof, and FIG. 4 is an end view thereof;

FIGS. 5-6 illustrate the annular hose support of FIGS. 1-4, wherein one or more of individual receivers are optionally adapted for receiving different sizes of hoses or other cylindrical elements, such as a smaller or larger size hose or other cylindrical object;

FIGS. 7-9 illustrate installation of the annular hose support of FIGS. 1-4 installed on the pre-existing external tube and organizing and securing individual ones of a plurality of hoses thereto, wherein FIG. 7 illustrates a plurality of the annular hose supports being fitted over the pre-existing external tube, FIG. 8 illustrates the plurality of hoses being installed in the plurality of annular hose supports, and FIG. 9 illustrates the plurality of hoses being and the plurality of annular hose supports being secured to the pre-existing external tube;

FIGS. 10 and 11 illustrate an alternative hose anchor of the invention disclosed herein, wherein an anchor securing mechanism is intrinsic to an individual alternative hose support, wherein FIG. 10 is a pictorial view of the alternative hose anchor, and FIG. 11 is a side view thereof;

FIGS. 12 and 13 illustrate another alternative hose anchor of the invention disclosed herein, wherein an anchor securing mechanism is intrinsic to an individual alternative hose support, wherein FIG. 12 is a pictorial view of the alternative hose anchor, and FIG. 13 is a side view thereof;

FIGS. 14, 15 and 16 illustrate another alternative hose anchor of the invention disclosed herein, wherein an anchor securing mechanism is intrinsic to an individual alternative hose support, wherein FIG. 14 is a pictorial view of the alternative hose anchor, FIG. 15 is a side view thereof showing the intrinsic anchor securing mechanism configured in a secured condition, and FIG. 16 is another side view thereof showing the intrinsic anchor securing mechanism configured in a disengaged condition;

FIGS. 17 and 18 illustrate another alternative hose anchor of the invention disclosed herein, wherein an anchor securing mechanism is intrinsic to an individual alternative hose support, wherein FIG. 17 is a pictorial view of the alternative hose anchor, and FIG. 18 is a side view thereof; and

FIG. 19 illustrates the alternative hose anchors of the invention as illustrated in FIGS. 10-18 distributed along the tube.

### DETAILED DESCRIPTION OF PREFERRED EMBODIMENT

In the Figures, like numerals indicate like elements.

FIGS. 1-4 illustrate an annular hose support 10 shown in a reel formation having a substantially arcuate disc-shaped core 12 formed sandwiched between a pair of intrinsic flanges 14 and 16 spaced apart on either side thereof, with core 12 being recessed between flanges 14,16 and forming a recess 17 therebetween. Here, hose support 10 is formed with a substantially arcuate inner surface 18 and a substantially arcuate outer surface 20. Inner surface 18 is sized to substantially encompass a tube, such as a pre-existing tube fixed on an excavator or other equipment. As such, outer surface 20 is formed with an opening 22 into inner surface 18, which opening 22 is adapted to permit entry to inner surface 18 of such a tube and subsequently substantially close therearound such tube.

Outer surface 20 is intrinsically formed with a plurality of individual spaced-apart receivers 24 each adapted for receiving cylindrical elements, such as but not limited to hoses of an auxiliary hydraulic system. Receivers 24 are spaced at intervals and aligned substantially parallel to one another while being oriented substantially transverse of inner and outer surfaces 18, 20. Each receiver 24 is formed with a concave inner surface 26 defining a substantially part-circular notch with an opening 28 thereinto. Openings 28 are directed away from outer surface 20, and optionally each opening 28 is formed with an individual retention means 30. For example, retention means 30 is provided by a larger cross-section of material that inherently increases stiffness of openings 28 over wall 32 surrounding inner surfaces 26 of individual receivers 24, as well as between adjacent receivers 24. Receivers 24 thereby define a plurality of spaced-apart, substantially circular regions for supporting a plurality of hoses individually therein.

According to the single embodiment of FIGS. 1-4, outer surface 20 is formed with spaced apart flanges 14, 16. A recessed clamping surface 34 is formed between spaced apart flanges 14, 16. As illustrated in the side and end views of FIGS. 2 and 4, clamping surface 34 is optionally provided with a slight draft angle when hose support 10 is injection molded.

One or more reducing holes 36 are optionally formed through disc-shaped core 12 and flanges 14, 16. Such reducing holes 36, when present, reduce the quantity of material used in manufacturing hose support 10 and may aid in fitting hose support 10 on a tube during installation by, for example, reducing thickness of wall 32 of receivers 24.

Hose support 10 is formed of a resiliently deformable material by a suitable method, such as but not limited to injection molding. A suitable material is a flexible, soft and “rubbery” material such as but not limited to elastomers, i.e. rubbers, and other soft polymers preferably of about Shore A 80 hardness. One suitable material is Supplied by ExxonMobil Chemical under the tradename Santoprene 8201-80 which is a thermoplastic vulcanizate, a soft, colorable, non-hygroscopic thermoplastic vulcanizate (TPV) in the thermoplastic elastomer (TPE) family.

FIGS. 2 and 4 show outer surface 20 and edge views of flanges 14, 16. FIG. 2 is a side view showing opening 28 through outer surface 20 into receiver 24 and concave inner surface 26 thereof. FIG. 4 is an end view showing opening 22 through outer surface 20 into inner surface 18. When molded, such as by injection molding or other suitable process, outer surface 20 may include a slight draft angle to help the mold release, which may cause an appearance of outer surface 20 having a slight change in diameter and one of flanges 14, 16 being larger than the other, but outer surface 20 is substantially cylindrical and flanges 14, 16 are substantially the same.

As further disclosed herein, individual receivers 24 are optionally adapted for receiving different sizes of hoses 3 or other cylindrical elements. For example, one or more individual receiver 24 is optionally scaled down to a smaller size for accommodating a smaller hose 3 or other cylindrical object.

FIG. 5 and FIG. 6 illustrate hose support 10, wherein one or more of individual receivers 24 is optionally adapted for receiving different sizes of hoses 3 or other cylindrical elements. For example, one individual receiver 24a is scaled down to a smaller size for accommodating a smaller hose 3a or other cylindrical object, as disclosed herein.

FIGS. 7-9 illustrate installation of hose support 10 installed on a tube 1, such as but not limited to a pre-existing tube fixed on an excavator or other equipment. In FIG. 7, opening 22 is spread to permit entry of tube 1 to inner surface 18 of hose support 10. Resiliently deformable material of hose support 10 suitably resiliently distorts to accommodate diameter of tube 1 and conform thereto when tube 1 is larger than original relaxed size and shape of inner surface 18. In operation, a plurality of hose supports 10 are distributed at intervals along tube 1 in a manner suitable for supporting one or more hoses.

FIG. 8 illustrates multiple hoses 3, such as but not limited to hoses of an auxiliary hydraulic system, installed on the plurality of hose supports 10 mounted on existing tube 1 of an excavator or other equipment. Openings 28 are spread and hoses 3 are pushed through into receivers 24 which resiliently deform to conform thereto when hose 3 is larger than original relaxed size and shape of inner surface 26. Optional individual retention means 30, if present, substantially automatically at least partially closes opening 28 and operates to at least initially individually retain hoses 3 in different ones of receivers 24. Hoses 3 are similarly installed in receivers 24 of each remaining one of plurality of hose supports 10.

FIG. 9 illustrates a hose anchor 38 of the invention. Hose anchor 38 includes hose supports 10 in combination with a securing mechanism 40 adapted for securing hoses 3 to individual hose supports 10, and securing individual hose supports 10 to external tube 1. Securing mechanism 40 is optionally either intrinsic to individual hose supports 10, or an extraneous securing element independent of hose support 10, as illustrated here. Extraneous securing element 40 is seated against outer surface 20 between flanges 14, 16 where it rests in recess 17 against areas 1a of tube 1 exposed in opening 22 and areas 3b of hoses 3 exposed in openings 28.

Securing mechanism 40 is effectively nonstretchable or at least stretch-resistant. By example and without limitation, extraneous securing mechanism 40 is a cable tie, also known as a zip tie or tie-wrap, which is a type of fastener, especially for binding several electronic cables or wires together and to organize cables and wires. In its common form, the nylon cable tie-type securing mechanism 40 consists of an elongated flexible strap portion 42 forming a tape section with an integrated gear rack 44 on one side formed by triangular teeth that slope in one direction. The head of cable tie-type securing mechanism 40 has a ratchet 46 within a small open case 48. A pointed tip 50 of tape section 42 is inserted into case 48 and past the ratchet 46, wherein a flexible pawl that rides up the slope of gear rack teeth 44 as tape section 42 is pulled through case 48 and past the ratchet 46. The pawl engages the backside of these gear rack teeth 44 to stop removal of tape section 42. Tape section 42 is thus prevented from being pulled back through case 48, and the resulting loop may only be pulled tighter, whereby hoses 3 are stabilized on tube 1. Because extraneous cable tie-type securing mechanism 40 is nylon or similar non-metallic material, both hose support 10 and hoses 3 are protected against damage from contact therewith.

Alternatively, extraneous securing mechanism 40 is a hose clamp, also known as a hose clip, which is a type of fastener, especially for attaching and sealing a hose onto a fitting such as a barb or nipple. Any of several available types of hose clamp may be utilized as extraneous securing mechanism 40 without deviating from the scope and intent of the present invention. Extraneous hose clamp-type securing mechanism 40 is optionally encased in an elastomeric sheath or coating for protecting both hose support 10 and hoses 3 against damage by contact therewith.

FIGS. 10 and 11 illustrate an alternative hose anchor 138 of the invention, wherein an alternative anchor securing mechanism 140 is intrinsic to an individual alternative hose support 100. Alternative hose support 100 is formed of a suitable flexible material such as but not limited to nylon or similar non-metallic material. Hose support 100 is formed with a substantially arcuate inner surface 118 and a substantially arcuate outer surface 120. Inner surface 118 is sized to substantially encompass a tube, such as a pre-existing tube fixed on an excavator or other equipment. As such, outer surface 120 is formed with an opening 122 into inner surface 118, which opening 122 is adapted to permit entry to inner surface 118 of such a tube and subsequently substantially close therearound such tube.

Outer surface 120 of alternative hose support 100 is intrinsically formed with a plurality of individual receivers 124 adapted for receiving cylindrical elements, such as but not limited to hoses of an auxiliary hydraulic system. Receivers 124 are spaced apart at intervals and aligned substantially parallel to one another while being oriented substantially transverse of inner and outer surfaces 118, 120. Each receiver 124 is formed with a concave inner surface 126 defining a substantially part-circular notch with an opening 128 thereinto. Openings 128 are directed away from outer surface 120, and optionally each opening 128 is formed with an individual intrinsic retainer 130. For example, individual intrinsic retainer 130 is provided by a larger cross-section of material that inherently increases stiffness of openings 128 over wall 132 surrounding inner surfaces 126 of individual receivers 124 for retaining hose 3 inserted therein. Receivers 124 thereby define a plurality of spaced substantially circular regions for supporting a plurality of hoses individually therein.

By example and without limitation, intrinsic securing mechanism 140 of alternative hose anchor 138 is similar to a cable tie of nylon or another suitable nonstretchable or stretch-resistant material. Here, intrinsic cable tie-type securing mechanism 140 consists of an elongated flexible strap portion 142 of a suitable nonstretchable or stretch-resistant material forming a tape section with an integrated gear rack 144 on one side formed by triangular teeth that slope in one direction. The head of cable tie-type securing mechanism 140 has a ratchet 146 within a small open case 148 and one end 142a of tape section 142 that is intrinsically formed with hose support 100. Tape section 142 includes the integrated gear rack 144 on one side formed by triangular teeth that slope in one direction. The head of cable tie-type securing mechanism 140 has a ratchet 146 within open case 148. A tip 150 of tape section 142 is inserted into case 148 and past the ratchet 146, wherein a flexible pawl that rides up the slope of gear rack teeth 144 as tape section 142 is pulled through case 148 and past the ratchet 146. The pawl engages the backside of these gear rack teeth 144 to stop removal of tape section 142. Tape section 142 is thus prevented from being pulled back through case 148, and the resulting loop may only be pulled tighter, whereby hose support 100 is stabilized on tube 1. Nonstretchable or stretch-resistant material resists loosening of securing mechanism 140. Because extraneous cable tie-type securing mechanism 140 is nylon or similar non-metallic material, tube 1 is protected against damage from contact therewith.

As further illustrated in FIG. 10, individual receivers 124 are optionally adapted for receiving different sizes of hoses 3 or other cylindrical elements. For example, one individual receiver 124a (left) is scaled down to a smaller size for accommodating a smaller hose 3a or other cylindrical object.

FIGS. 12 and 13 illustrate another alternative hose anchor 238 of the invention, wherein disclosed securing mechanism 140 is intrinsic to an alternative hose support 200. Alternative hose support 200 is formed of the suitable flexible material such as but not limited to nylon or similar non-metallic material.

Outer surface 220 of alternative hose support 200 is intrinsically formed with a plurality of alternative individual receivers 224 adapted for receiving cylindrical elements, such as but not limited to hoses of an auxiliary hydraulic system. Receivers 224 are spaced-apart at intervals and aligned substantially parallel to one another while being oriented substantially transverse of inner and outer surfaces 218, 220 of hose support 200. Each receiver 224 is formed with a concave inner surface 226 defining a substantially part-circular notch with an opening 228 thereinto. Openings 228 are directed away from outer surface 220, and optionally each opening 228 is formed with an individual intrinsic retainer 230. For example, individual intrinsic retainer 230 is provided by a ratchet 232 formed of a pawl 234 formed on a flexible stem 236. A flexible arm 240 of receiver 224 is extended from outer surface 224 of hose support 200 and includes a gear tooth 242 matched to the pawl 234 and positioned at one end thereof adjacent to opening 228. After hose 3 is inserted into receiver 224 through opening 228, flexible arm 240 is pressed around inserted hose 3 until gear tooth 242 engages pawl 234, whereupon gear tooth 242 interlocks with pawl 234 for retaining hose 3 inserted in receiver 224. Hose 3 is thereby secured in receiver 224.

As further illustrated in FIG. 13, individual receivers 224 are optionally adapted for receiving different sizes of hoses 3 or other cylindrical elements. For example, one individual receiver 224a is scaled down to a smaller size for accommodating smaller hose 3a or other cylindrical object.

FIGS. 14, 15 and 16 illustrate another alternative hose anchor 338 of the invention, wherein an alternative anchor securing mechanism 340 is intrinsic to an alternative hose support 300. Outer surface 320 of alternative support 300 is formed with a plurality of disclosed alternative individual receivers 224, as disclosed herein, which are spaced at intervals and aligned substantially parallel to one another while being oriented substantially transverse of inner and outer surfaces 318, 320 of hose support 300. Each receiver 224 is formed with concave inner surface 226 defining substantially part-circular notch with opening 228 directed away from outer surface 220, with each opening 228 optionally formed with individual intrinsic retainer 230 disclosed herein.

By example and without limitation, intrinsic securing mechanism 340 of alternative hose anchor 338 is formed of nylon or another suitable flexible, nonstretchable or stretch-resistant material. Here, intrinsic securing mechanism 340 consists of a flexible band 342 terminating in a pair of interleaving arms 344, 346 forming an opening 348 through outer surface 320 into inner surface 318. Interleaving arms 344, 346 are formed with integrated gear racks 350, 352 which interlock. Interleaving arms 344, 346 are thus prevented from disengaged, and the resulting loop may only be forced tighter, whereby hose support 300 is stabilized on tube 1. Optionally, an interior arm 354 of inner surface 318 may be extended at least partially between interleaving arms 344, 346 and tube 1. Because intrinsic securing mechanism 340 is nylon or similar non-metallic material, tube 1 is protected against damage from contact therewith. An optional exterior arm 356 of outer surface 320 may be extended at least externally of interleaving arm 346 for aiding in securing interlocking of gear racks 350, 352.

FIGS. 17 and 18 illustrate another alternative hose anchor 438 of the invention, wherein disclosed alternative securing mechanism 340 is intrinsic to an alternative hose support 400. Outer surface 420 of alternative support 400 is formed with a plurality of disclosed alternative individual receivers 124 adapted for receiving cylindrical elements, such as but not limited to hoses of an auxiliary hydraulic system. Receivers 124 are spaced at intervals and aligned substantially parallel to one another while being oriented substantially transverse of inner and outer surfaces 418, 420 of hose support 400. Each receiver 124 is formed with concave inner surface 126 defining a substantially part-circular notch with opening 128 thereinto and directed away from outer surface 420, with each opening 128 optionally formed with individual intrinsic retainer 130 providing increased stiffness over surrounding wall 132.

By example and without limitation, disclosed intrinsic securing mechanism 340 of alternative hose anchor 438 is formed of nylon or another suitable material, and consists of flexible band 342 terminating in interleaving arms 344, 346 each formed with interlocking integrated gear rack 350, 352, whereby interleaving arms 344, 346 are prevented from disengaging.

FIG. 19 illustrates alternative hose anchor 138, alternative hose anchor 238, alternative hose anchor 338 and alternative hose anchor 438 of the invention distributed along tube 1. One or a plurality of any one or more of hose anchor 38 of the invention, or alternative hose anchors 138, 238, 338 and 438 of the invention, or any combination thereof may be used for organizing and securing individual ones of a plurality of hoses 3. Such hoses 3 may be, but are not limited to, hoses of an auxiliary hydraulic system secured to pre-existing external tube 1 of an excavator or other equipment in a manner that permits the hose to deliver accurate hydraulic flow and pressure.

Individual alternative hose support 100 of alternative hose anchor 138 is secured to tube 1 by intrinsic securing mechanism 140 thereof. Tape section 142 of cable tie-type intrinsic securing mechanism 140 is fed through case 148 where gear rack teeth 144 interlock with ratchet 146. Tape section 142 is thus prevented from being pulled back through case 148, and the resulting loop may only be pulled tighter, whereby hose support 100 is stabilized on tube 1.

Individual alternative hose support 200 of alternative hose anchor 238 is similarly secured to tube 1 by intrinsic securing mechanism 140 thereof.

Individual alternative hose support 300 of alternative hose anchor 338 is secured to tube 1 by intrinsic securing mechanism 340 thereof. Interleaving arms 344, 346 are and flexible band 342 is fit over tube 1. Thereafter, arms 344, 346 are interleaved and gear rack 348, 350 thereof are interlocked, whereby hose support 300 is stabilized on tube 1.

Individual alternative hose support 400 of alternative hose anchor 438 is similarly secured to tube 1 by intrinsic securing mechanism 340 thereof.

When one or both of alternative hose supports 100 and 400 is utilized, hose 3 is inserted through opening 128 into one of individual receivers 124 on outer surfaces 120 and 420 of alternative hose supports 100 and 400, respectively. Thereafter, individual intrinsic retainer 130 of individual receivers 124 operates for retaining hose 3 inserted therein.

When one or both of alternative hose supports 200 and 300 is utilized, hose 3 is inserted through opening 228 into one of individual receivers 224 on outer surfaces 220 and 320 of alternative hose supports 200 and 300, respectively. Thereafter, individual intrinsic retainer 230 of individual receivers 224 operates for retaining hose 3 inserted therein.

While the preferred and additional alternative embodiments of the invention have been illustrated and described, it will be appreciated that various changes can be made therein without departing from the spirit and scope of the invention. Accordingly, the inventor makes the following claims.

1. A hose retainer adapted for securing individual ones of a plurality of hoses, the hose anchor comprising:
a hose support comprising an outer surface and an inner surface with an opening therebetween, the inner surface adapted to at least partially encompass an external tube member;
a plurality of receivers positioned on the outer surface of the hose support, each receiver comprising an opening thereinto and being adapted for receiving an extraneous element;
a retainer adapted for retaining the extraneous element received into each receiver; and
a securing mechanism adapted for securing the hose support to the external tube member.

2. The hose retainer of claim 1, wherein the hose support further comprises a resiliently deformable material.

3. The hose retainer of claim 2, wherein the resiliently deformable material further comprises a thermoplastic elastomer.

4. The hose retainer of claim 1, wherein the plurality of receivers are mutually parallel.

5. The hose retainer of claim 4, wherein the inner surface of the hose support is further mutually parallel with the plurality of receivers.

6. The hose retainer of claim 1, wherein the securing mechanism further comprises one of: an intrinsic securing element continuous with the hose support, and an extraneous securing element independent of the hose support.

7. The hose retainer of claim 6, wherein the hose support further comprises a core between a pair of flanges spaced apart to receive the securing mechanism therebetween.

8. The hose retainer of claim 7, wherein the securing mechanism further comprises the independent extraneous securing element comprising an elongated strap portion that is further sized to be received between the pair of spaced apart flanges.

9. The hose retainer of claim 8, wherein the independent extraneous securing element further comprises one of a hose clamp and a cable tie.

10. The hose retainer of claim 6, wherein the hose support further comprises the intrinsic securing element, and wherein each receiver further comprises an opening thereinto formed with an individual intrinsic retainer.

11. The hose retainer of claim 10, wherein each receiver further comprises one of:
a concave inner surface defining a substantially part-circular notch with opening thereinto and directed away from the outer surface of the hose support, and the individual intrinsic retainer further comprises a stiffness formed about the opening that is greater than a stiffness of a wall partially surrounding the opening; and
a concave inner surface defining a substantially part-circular notch with an opening thereinto and directed away from the outer surface of the hose support, and the individual intrinsic retainer further comprises a ratchet formed of a pawl formed on a flexible stem and a flexible arm comprising a gear tooth matched to the pawl and positioned adjacent to the opening into the concave inner surface.

12. The hose retainer of claim 10, wherein the intrinsic securing element of the hose support further comprises one of:
an elongated flexible strap portion comprising a gear rack, and an open case portion adapted to receive the strap portion thereinto and further comprising a ratchet within the open case and adapted for interlocking with the gear rack of the strap portion; and
a pair of interleaving arms forming the opening of the hose support, the interleaving arms further comprising mutually interlocking gear racks.

13. The hose retainer of claim 2, wherein one or more of the plurality of receivers is adapted for receiving an extraneous element of a different size than another one of the plurality of receivers.

14. A hose retainer adapted for securing individual ones of a plurality of hoses, the hose anchor comprising:
a hose support comprising a flexible outer surface and a flexible inner surface and a flexible opening therebetween, the opening adapted to receive therethrough an external tube member, the inner surface adapted to substantially encompass the external tube member;
a plurality of flexible receivers positioned on the outer surface of the hose support, each receiver comprising a flexible opening thereinto and being adapted for receiving an extraneous element;
a retainer adapted for retaining the extraneous element received into each receiver; and
a securing mechanism comprising a stretch-resistant material and adapted for securing the hose support to the external tube member.

15. The hose retainer of claim 14, wherein the hose support further comprises a resiliently deformable material.

16. The hose retainer of claim 15, wherein the securing mechanism further comprises one of: an intrinsic securing element continuous with the hose support, and an extraneous securing element independent of the hose support.

17. The hose retainer of claim 16, wherein the securing mechanism further comprises the independent extraneous securing element comprising an elongated strap portion that is further sized to be received around the hose support externally of the plurality of receivers positioned on the outer surface thereof.

18. The hose retainer of claim 16, wherein the hose support further comprises the intrinsic securing element, and wherein each receiver further comprises an opening thereinto formed with an individual intrinsic retainer.

19. A method of securing one or more hoses individually to a pre-existing tube, the method comprising:
fitting a hose support over the pre-existing tube, wherein the hose support further comprises an outer surface and an inner surface with an opening therebetween, the inner surface adapted to at least partially encompass the pre-existing tube;
installing a hose in the hose support, comprising inserting the hose into a receiver positioned on the outer surface of the hose support;
securing the hose to the hose support; and
securing the hose support to the pre-existing tube.

20. The method of claim 19, wherein fitting the hose support over the pre-existing tube further comprises resiliently deforming at least the opening between the inner and outer surfaces of the hose support for receiving the pre-existing tube therethrough.

21. The method of claim 20, wherein the hose support further comprises a plurality of the receivers positioned on the outer surface thereof;
wherein installing the hose in the hose support further comprises installing a plurality of hoses in the hose support by inserting each hose into one of the plurality of receivers; and
wherein securing the hose to the hose support further comprises securing of the plurality of hoses to the hose support.

22. The method of claim 20, wherein fitting a hose support over the pre-existing tube further comprises fitting a plurality of the hose supports over the pre-existing tube;
wherein installing a hose in the hose support further comprises installing the hose in each of the hose supports by inserting the hose into the receiver of each hose support;
wherein securing the hose to the hose support further comprises securing the hose to each of the plurality of hose supports; and
wherein securing the hose support to the pre-existing tube further comprises securing each of the plurality of hose supports to the pre-existing tube.

23. The method of claim 22, wherein each hose support further comprises a plurality of the receivers positioned on the outer surface thereof;
wherein installing the hose in each of the hose supports further comprises installing a plurality of hoses in a plurality of the hose supports by inserting the hoses into one of the plurality of receivers of a plurality of the hose supports; and
wherein securing the hose to the hose support further comprises securing each of the plurality of hoses to the hose supports.

24. The method of claim 19, wherein securing the hose to the hose support further comprises securing the hose with on of: an intrinsic securing element continuous with the hose support, and an extraneous securing element independent of the hose support.

25. The method of claim 24, wherein securing the hose to the hose support with an extraneous securing element independent of the hose support further comprises securing the hose to the hose support with an elongated strap portion that is further sized to be received around all of the hose, the hose support, and the pre-existing tube.

26. The method of claim 24, further comprising securing the hose to the hose support with the intrinsic securing element continuous with the hose support; and
wherein securing the hose to the hose support further comprises receiving the hose into a receiver positioned on the outer surface of the hose support.

27. The method of claim 25, wherein receiving the hose into a receiver further comprises receiving the hose through an opening thereinto; and
wherein securing the hose to the hose support further comprises securing the hose in the receiver with a retainer intrinsic to the receiver.

28. The method of claim 26, wherein securing the hose in the receiver with a retainer intrinsic to the receiver further comprises securing the hose with a retainer adjacent to the opening into the receiver.
